(19) United States
(12) Patent Application Publication
(10) Pub. No.: US 2013/0077664 A1
(43) Pub. Date: Mar. 28, 2013

(54) METHOD AND SYSTEM FOR ASSOCIATION BETWEEN CONTROLLER AND DEVICE IN HOME NETWORK

(71) Applicant: Chung Hee Lee, Gyeonggi-do (KR)

(72) Inventor: Chung Hee Lee, Gyeonggi-do (KR)

(21) Appl. No.: 13/418,191

(22) Filed: Mar. 12, 2012

(30) Foreign Application Priority Data
Sep. 27, 2011 (KR) 10-2011-0097817

(51) Int. Cl. H04B 1/38

(52) U.S. Cl. 375/222

(57) ABSTRACT

A system and method for associating a controller and a device in a home network. The method includes using a master modem for: (a) registering unique information of a specific device when a controller requests a registration of the specific device; (b) receiving information including unique information of a household device from a slave modem using the home network; (c) determining whether the unique information of the household device exists on the registered information; (d) if it is determined that the unique information of the household device does not exist, requesting an exclusion of the household device requesting the association and excluding the household device from the home network association; and (e) if it is determined that the unique information of the household device exists, performing the home network association by transmitting the unique information of the household device, which is received from the slave modem, to the controller.

### CROSS-REFERENCE TO RELATED APPLICATIONS

This application claims the benefit of Korean Patent Application No. 10-2011-0097817 filed with the Korea Intellectual Property Office on Sep. 27, 2011 the disclosure of which is incorporated herein by reference.

### BACKGROUND OF THE INVENTION

1. Field of the Invention

The present invention relates to a method and system for association between a controller and a device in a home network. In particular, the present invention relates to a method and system for association between a controller and a device in a home network, capable of preventing incorrect association with a device belonging to other home network.

2. Description of the Related Art

At present, many attempts have been made to implement a Home Area Network (HAN) system. A variety of communication technologies may be used to implement an HAN system. In addition, a variety of association methods may be used between a controlled device and a controller serving as a coordinator. A wired communication or a wireless communication may be used depending on a kind of the communication technology used in the HAN system. A TCP-IP or a power line communication (PLC) may be used as the wired communication, and a wireless LAN, a ZigBee, a Bluetooth, or an RFID may be used as the wireless communication. Home servers such as a gateway or a wall pad may be used depending on a kind of the controller. Examples of the controlled device may include home appliances and sensors.

According to typical association methods, each device finds a master modem having strong signal strength and automatically associates with the found master modem. However, in such association methods, a device belonging to a certain home network may perform an association by detecting a signal of a master modem belonging to an adjacent home network which is located at a short distance from the device and has a strong signal strength. Thus, the device may not associate with a master modem of an originally intended home network which is located at a long distance and has a weak signal strength.

### SUMMARY OF THE INVENTION

The present invention has been invented in order to overcome the above-described problems and it is, therefore, an object of the present invention to provide technology for association between a controller and a device in a home network, capable of preventing incorrect association with a device belonging to other home network.

In accordance with one aspect of the present invention to achieve the object, there is provided a method for association between a controller and a device in a home network, which includes: (a) registering, by a master modem, unique information of a specific device when the controller requests a registration of the specific device; (b) receiving, by the master modem, information including unique information of a household device from a slave modem through a home network communication association procedure; (c) determining, by the master modem, whether the unique information of the household device received through the home network communication association procedure exists on the registered information; (d) if it is determined that the unique information of the household device does not exist, requesting, by the master modem, an exclusion of the household device requesting the association according to the home network communication association procedure, and excluding the household device from the home network association; and (e) if it is determined that the unique information of the household device exists, performing, by the master mode, the home network association by transmitting the unique information of the household device, which is received from the slave modem, to the controller.

Step (e) may include: (e-1) allocating, by the master modem, a logical address corresponding to the equipment information of the household device received from the slave modem; (e-2) transmitting, by the master modem, information of the logical address allocated in step (e-1) and the equipment information to the controller, and registering, by the controller, the logical address and the equipment information; and (e-3) transmitting, by the master modem, the information of the logical address allocated in step (e-1) to the slave modem of the corresponding household device, and registering, by the slave modem, the information of the logical address, and the method may further include: (f) requesting, by the controller, the control of the household device to the master modem by using the registered logical address of the household device, and controlling, by the master modem, the household device by transmitting a control request of the household device by using the unique information of the household device corresponding to the logical address.

Step (f) may include: (f-1) requesting, by the controller, the control of the household device to the master modem by using the registered logical address of the household device; (f-2) transmitting, by the master modem, the household device control request to the slave modem of the household device by using the unique information of the household device corresponding to the logical address; (f-3) controlling, by the slave modem, the household device according to the control request, receiving a control response from the household device, and transmitting a control response signal to the master modem; and (f-4) transmitting, by the master modem, the received control response signal to the controller.

In step (e), the equipment information of the household device transmitted to the controller may be contained in the information including the unique information of the household device received by the master modem through the home network communication association procedure in step (b), and the master modem may allocate a logical address corresponding to the equipment information of the household device and transmit the logical address and the equipment information to the controller.

In step (e), the equipment information of the household device transmitted to the controller may be information received by requesting to the slave modem after it is determined in step (c) that the unique information of the household device exists, and the master modem may allocate a logical address corresponding to the equipment information of the household device and transmit the logical address and the equipment information to the controller.

The unique information of the device may be MAC address and, in step (e), the master modem may allocate a logical address corresponding to the equipment information of the household device and transmit the logical address and the equipment information to the controller.

The logical address may be a fixed address allocated to the household device.

The master modem may be a ZigBee master, and the slave modem may be a ZigBee slave.

In accordance with another aspect of the present invention to achieve the object, there is provided a system for association between a controller and a device in a home network, which includes: a controller configured to communicate with a household device belonging to the home network and control the household device; a master modem configured to register unique information of a specific device according to a specific device registration request from the controller, determine whether the unique information of the household device received from a slave modem of the household device through a home network communication association procedure exists on the registered information, request an exclusion of the household device if it is determined the unique information does not exist, and transmit the unique information of the household device received from the slave modem to the controller if it is determined that the unique information exists; a slave modem installed on the household device and configured to communicate with the master modem, request the home network communication association of the household device to the master modem, transmit information including the unique information of the household device to the master modem through the home network communication association procedure, perform exclusion of the household device if received an exclusion request from the master modem, and transmit equipment information of the household device to the master modem; and the household device configured to associate with the controller through the slave modem and be controlled through the slave modem according to a control request from the associated controller.

The master modem may allocate a logical address corresponding to the equipment information of the household device received from the slave modem, transmit the allocated logical address to the slave modem, perform the home network communication association by transmitting the allocated logical address and the equipment information to the controller, and transmit a control request to the slave modem by using the unique information of the household device according to the household device control request from the controller, and the controller may register the logical address and the equipment information received from the master modem, and request the control of the household device to the master modem by using the registered logical address of the household device.

The slave modem may control the household device according to the control request, receive a control response from the household device, and transmit a control response signal to the master modem, and the master modem may transmit the received control response signal to the controller.

The unique information of the device may be MAC address, and the logical address may be a fixed address allocated to the household device.

The master modem may be a ZigBee modem, and the slave modem may be a ZigBee slave.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart schematically showing a method for association between a controller and a device in a home network in accordance with an embodiment of the present invention;

FIG. 2 is a flowchart schematically showing a part of a method for association between a controller and a device in a home network in accordance with another embodiment of the present invention;

FIG. 3 is a flowchart schematically showing a method for association between a controller and a device in a home network in accordance with another embodiment of the present invention;

FIG. 4 is a block diagram schematically showing a system for association between a controller and a device in a home network in accordance with an embodiment of the present invention; and

FIG. 5 is a diagram schematically showing a state required in a method for association between a controller and a device in a home network in accordance with an embodiment of the present invention.

### DETAILED DESCRIPTION OF THE PREFERABLE EMBODIMENTS

Embodiments of the present invention for achieving the above objects will be described with reference to the accompanying drawings. In the specification, like reference numerals denote like elements, and duplicate or redundant descriptions will be omitted for conciseness.

It will be understood that when an element is referred to as being ‘connected to’ or ‘coupled to’ another element, it may be directly connected or coupled to the other element or at least one intervening element may be present therebetween. In contrast, when an element is referred to as being ‘directly connected to’ or ‘directly coupled to’ another element, there are no intervening element therebetween.

It should be noted that the singular forms ‘a″an’ and ‘the’ are intended to include the plural forms as well, unless the context clearly indicates otherwise.

It should be understood that the terms ‘comprise’, ‘include’ and ‘have’, when used in this specification, specify the presence of stated features or elements, but do not preclude the presence or addition of one or more other features, elements, or combinations thereof.

First, a method for association between a controller and a device in a home network in accordance with first embodiments of the present invention will be described in detail. Reference numerals that are not shown in the relevant drawings may refer to elements shown in other drawings. In this case, it should refer to elements shown in other drawings.

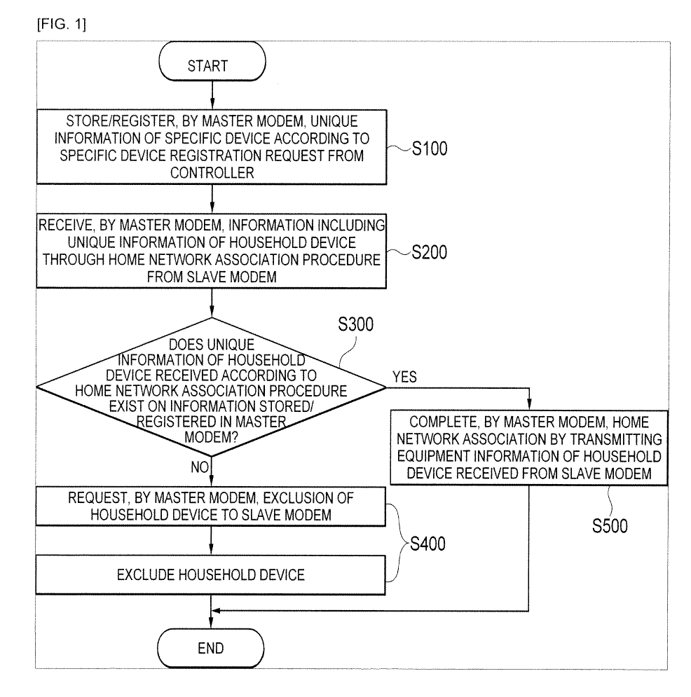

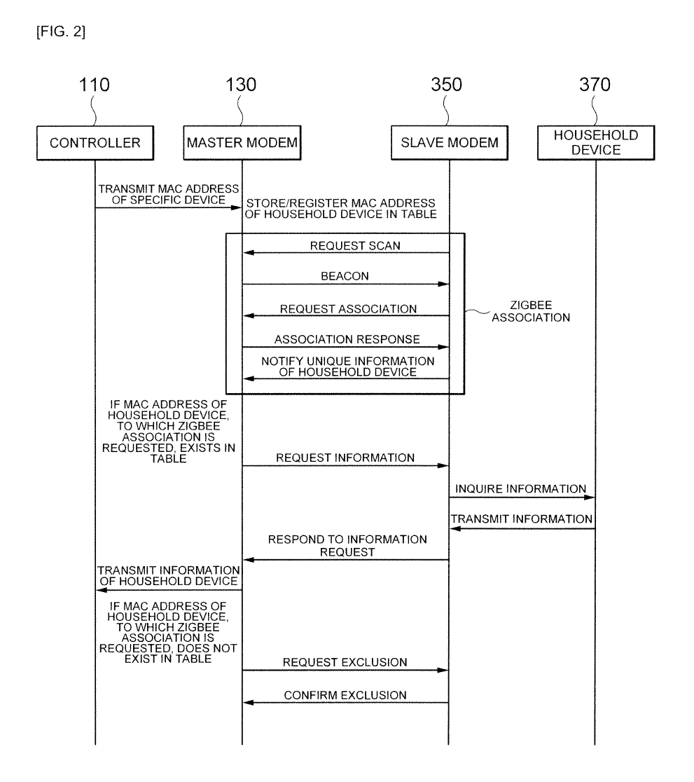

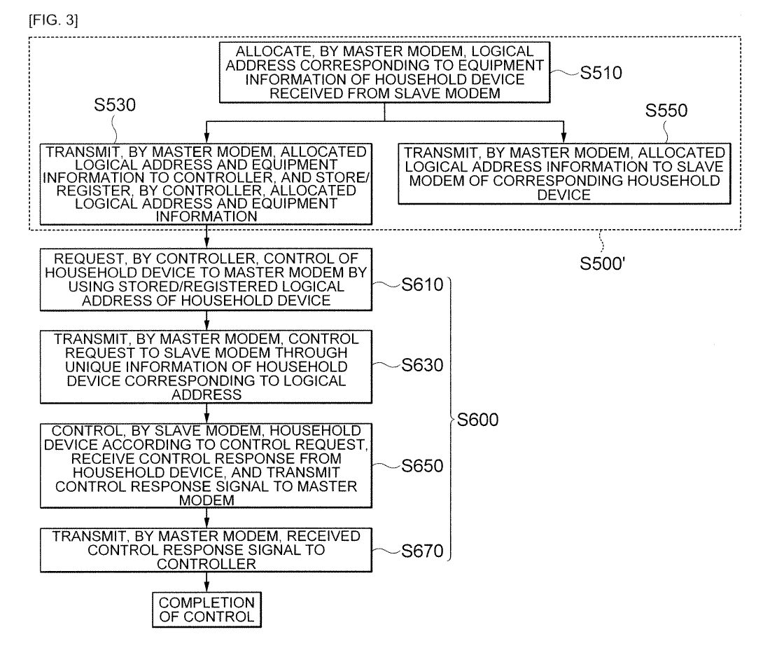

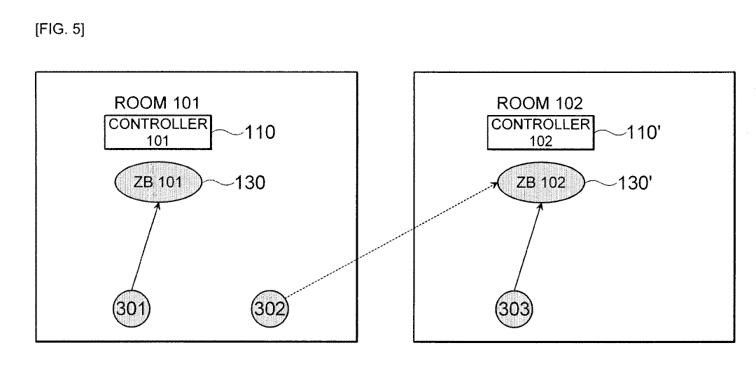

FIG. 1 is a flowchart schematically showing a method for association between a controller and a device in a home network in accordance with an embodiment of the present invention, and FIG. 2 is a flowchart schematically showing a part of a method for association between a controller and a device in a home network in accordance with another embodiment of the present invention. FIG. 3 is a flowchart schematically showing a method for association between a controller and a device in a home network in accordance with another embodiment of the present invention, and FIG. 5 is a diagram schematically showing a state required in a method for association between a controller and a device in a home network in accordance with an embodiment of the present invention.

Referring to FIGS. 1 and 2, a method for association between a controller 110 and a device 100 in a home network in accordance with an embodiment of the present invention includes steps (a), (b), (c), (d) and (e) (S100, S200, 5300, 5400 and S500 in FIG. 1). For example, the home network may be a ZigBee communication network system. A master modem 130 may be a ZigBee master, and a slave modem 350 may be a ZigBee slave.

In step (a) S100, a master modem 130 registers unique information of a specific device in response to a specific device registration request from a controller 110. Referring to FIG. 2, the unique information of the device may be MAC address. The master modem 130 may be a ZigBee master installed in a home network, a gateway, or a wall pad 100. The specific device, whose registration is requested by the controller 110, is a household device whose association is permitted in a home network system.

In this step, information of the household device whose association is permitted may be previously registered in the master modem 130 through the controller 110. When a user inputs the information of the specific household device, whose home network association is permitted, through a home network server, a gateway, or a wall pad 100, the controller 110 may transmit the unique information of the household device to the master modem 130. In addition, the information of the household device may be provided through the master modem 130 to the controller 110 by an association procedure according to a home network communication association request from the slave modem 350 of the household device. In this case, if the information of the household device is displayed in the home network server, the gateway, or the wall pad 100 through the controller 110, the association of the specific household device may be permitted when the user selects the displayed information. The unique information of the household device whose association is permitted may be transmitted from the controller 110 to the master modem 130 and be registered and/or stored therein.

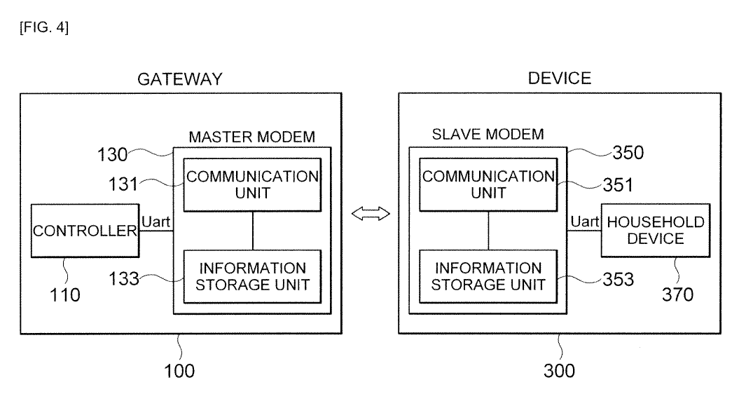

In this step, the master modem 130 having received the specific household device registration request from the controller 110 may store and/or register the unique information of the specific household device. Referring to FIG. 4, the unique information of the household device may be stored in an information storage unit 133 of the master modem 130. The unique information of the household device may be previously registered in a table of the information storage unit 133 or a linked table.

In addition, when the controller 110 requests the registration of the specific device, the controller 110 may transmit device equipment information as well as the unique information of the specific device to the master modem 130. In this case, the master modem 130 may allocate a logical address to corresponding to the equipment information of the household device by using the device equipment information as well as the unique information of the specific device.

Although not shown, before step (a) S100, a process may be performed when the controller 110 is initially powered on. For example, when the controller 110 is powered on, the controller 110 transmits a modem information request signal to the master modem 130. The master modem 130 reads the modem information thereof from the information storage unit 133 of FIG. 4 and transmits the read modem information to the controller 110 through a modem information response. The modem information may include a physical address and a logical address (for example, building number and room number of apartment, device ID (e.g., the device ID of the master modem 130 is 0)). If there is no modem information, the master modem 130 may transmit a NULL value to the controller 110.

If there is a logical address value among the modem information of the master modem 130, the controller 110 may transmit a signal requesting entire device information to the master modem 130. Meanwhile, if the power-on of the controller 110 is not initial, the entire device information may be previously stored in a memory of the controller 110. The device information refers to address information and equipment information, e.g. type information, of a currently registered device. The address information includes a physical address and a logical address. The logical address refers to an address allocated to building number and room number of apartment and device ID. The type information is 2-byte information. For example, 0x0120 may represent a drum washing machine and 0x0121 may represent a drum washing machine (domestic). 0x0210 may represent a refrigerator and 0x0211 may represent a refrigerator (domestic). The master modem 130 reads the entire device information from the information storage unit 133 according to the request of the controller 110 and transmits the read information to the controller 110. If the logical address among the modem information of the master modem 130 is NULL, the master modem 130 is in a clear state. Thus, the master modem 130 needs to inform a logical address to be installed. Therefore, the controller 110 transmits a logical address setting signal to the master modem 130. The master modem 130 transmits a logical address setting response.

Accordingly, in step (a) S100 of FIG. 1, the controller 110 may complete the preparation for registration request of the specific device to the master modem 130.

Next, in step (b) S200, the master modem 130 receives information including unique information of a household device 300 or 370 from the slave modem 350 through a home network communication association procedure. In addition, the slave modem 350 may be a ZigBee slave installed in each household device 300.

The slave modem 350 and the master modem 130 may associate with each other through a standard or known association procedure according to a communication scheme. For example, the ZigBee association procedure will be described with reference to FIG. 2. If the household device 370 is powered on and the slave modem 350 transmits a scan request to the master modem 130, the master modem 130 transmits a beacon signal to the slave modem 350. Then, the slave modem 350 requests an association to the master modem 130, and the master modem 130 transmits a response to the association request. According to the response of the master modem 130, the slave modem 350 notifies the household device information to the master modem 130 and performs a ZigBee association procedure. In this case, the household device information notified from the slave modem 350 to the master modem 130 may include unique information of the household device 370 or 300, for example, MAC address. Although the ZigBee association procedure has been described with reference to FIG. 2, an association procedure of other near-field wireless communication may also be performed.

The household device information provided from the slave modem 350 to the master modem 130 through the association procedure may include equipment type information of the household device 370 or 300 as well as the unique information of the household device. The equipment type information may be information representing a washing machine, a refrigerator, a TV, and so on. The equipment type information is 2-byte information. For example, 0x0120 may represent a drum washing machine and 0x0121 may represent a drum washing machine (domestic). 0x0210 may represent a refrigerator and 0x0211 may represent a refrigerator (domestic).

In addition, the association procedure of the slave modem 350 and the master modem 130 may be started when the household device 370 or 300 is powered on. If the household device is powered on, the household device 370 or 300 may transmit equipment information thereof, e.g., type information, to the slave modem 350, and the slave modem 350 may store a physical address thereof, e.g., MAC address, and equipment information of the household device 370 or 300, e.g., type information, in an information storage unit 353. For example, the physical address and the equipment information stored in the information storage unit 353 of the slave modem 350 may be transmitted to the master modem 130 through the procedure of associating with the master modem 130. The physical address may be transmitted to the master modem 130 through the procedure of associating with the master modem 130. After it is determined that the physical address transmitted through the procedure of associating with the master modem 130 is already registered, the equipment information may be transmitted to the master modem 130 according to the request of the information of the household device 370 or 300 from the master modem 130.

Referring to FIGS. 1 and 2, in step (c) S300, the master modem 130 determines whether the unique information of the household device 370 received through the home network communication association procedure exists on the registered information. The unique information of the device may be MAC address. For example, as in the case of FIG. 2, the household device information notified from the slave modem 350 to the master modem 130 through the home network association procedure includes the unique information of the household device 370, e.g., MAC address. The master modem 130 compares the unique information (e.g., MAC address) of the household device, whose association is requested in the association procedure, with the information stored/registered in the information storage unit 133, e.g., the table of FIG. 2, and determines whether the unique information of the household device is registered.

In step (d) S400, if it is determined that the unique information of the household device does not exist, the master modem 130 requests an exclusion to the household device 370 requesting the association according to the home network communication association procedure, and the household device 370 is excluded in the home network association.

Referring to FIG. 2, if the same information as the unique information (e.g., MAC address) of the household device 370 requesting the association in the association procedure does not exist on the table, the master modem 130 requests the exclusion to the slave modem 350, and the slave modem 350 confirms the exclusion. In this manner, incorrect association may be prevented as will be described below with reference to FIG. 5.

In step (e) S500, if it is determined that the unique information of the household device 370 exists, the master modem 130 transmits the equipment information of the household device, which is received from the slave modem 350, to the controller 110, and performs the home network association. The unique information of the device may be MAC address.

The reason for needing the association procedure between the controller 110 and the controlled device 370 or 300 like in the embodiment is as follows.

Referring to FIG. 5, for example, when room 101 of an apartment is adjacent to room 102, separate controllers 110 and 110′ are installed because a home network is configured at each room of the apartment. In the room 101 of the apartment, there are household devices 301 and 302. In the room 102, there is a household device 103. The household device 301 well associates with the controller 110 of the room 101 through the association procedure with ZB 101, which is a master modem 130 of the room 101. The household device 303 well associates with the controller 110′ of the room 102 through the association procedure with ZB 102, which is a master modem 130′ of the room 102. However, since the household device 302 is located at the room 101 of the apartment, it should associate with the controller 110 of the room 101 through the association with the ZB 101, which is the master modem 130 of the room 101. However, the household device 302 may associate with the ZB 102, which is the master modem 130 of the room 102 of the apartment. For example, if the signal of the ZB 102 (130′) is stronger because than a distance between the household device 302 and the ZB 101(130) is farther than a distance between the household device 302 and the ZB 102 (130′) of the room 102 of the apartment, the household device 302 may associate with the ZB 102, which is the master modem 130′ of the room 102, not the ZB 101 (130). Therefore, there is a need for an association procedure between a controller and a device, capable of preventing incorrect association.

In addition, in step (e) S500, the equipment information of the household device 370 or 300, which is transmitted to the controller 110, may be included in the information containing the unique information of the household device 370 or 300, which is received by the master modem 130 through the home network communication association procedure in step (b) S200. The information containing the unique information of the household device, which is received by the master modern 130 through the home network communication association procedure, may be equipment type information.

In addition, in step (e) S500, the equipment information of the household device 370 or 300, which is transmitted to the controller 110, may be information received when the master modem 130 requests to the slave modem 350, after it is determined in step (c) S300 that the unique information of the household device exists.

Referring to FIG. 2, if the master modem 130 finds the same information as the unique information (e.g., MAC address) of the household device 370, whose association is requested during the association procedure, on the table, the master modem 130 requests the information of the household device 370 to the slave modem 350. The information of the household device may be equipment type information of the household device. The equipment type information is 2-byte information. For example, 0x0120 may represent a drum washing machine and 0x0121 may represent a drum washing machine (domestic). 0x0210 may represent a refrigerator and 0x0211 may represent a refrigerator (domestic). Then, the slave modem 350 inquires the information requested by the master modem 130 to the household device 370, and receives the information from the household device 370. The slave modem 350 receiving the information of the household device 370 transmits a response to the information request to the master modem 130, and the master modem 130 provides the received information to the controller 110. The controller 110 may display the received equipment information of the household device 370 or 300 on a display such as a home network server, a gateway or a wall pad 100, or may store/register the received equipment information of the household device in the home network server, the gateway, or the wall pad.

In addition, in step (e) S500, the master modem 130 allocates a logical address corresponding to the equipment information of the household device 370 or 300, and transmits the logical address and the equipment information to the controller 110. For example, the local address may be a fixed address allocated to each household device.

Although it has been described that the master modem 130 allocates the logical address in step (e) S500, if the master modem 130 receives the information containing the device equipment information as well as the unique information of the specific device upon reception of the specific device registration request from the controller 110 in step (a) S100, the master modem 130 may allocate the logical address corresponding to the equipment information of the household device 370 or 300 by using the device equipment information as well as the unique information of the specific device in step (a) S100.

Referring to FIG. 3, step (e) S500 may include steps (e-1), (e-2) and (e-3) (S510, S530 and S550).

In step (e-1) S510, the master modem 130 allocates a logical address corresponding to the equipment information of the household device, which is received from the slave modem 350.

In step (e-2) S530, the master modem 130 transmits the allocated logical address information and the equipment information to the controller 110, and the controller 110 registers the logical address and the equipment information.

In step (e-3) S550, the master modem 130 transmits the allocated logical address information to the slave modem 350 of the corresponding household device 300, and the slave modem registers the logical address information.

Referring to FIG. 3, a method for association between a controller and a device in a home network may further include step (f) S600. In step (f) S600, the controller 110 may request the control of the household device to the master modem 130 by using the registered logical address of the household device. The logical address may be a fixed address allocated to each household device. In addition, the master modem 130 may control the household device by transmitting the household device control request using the unique information of the household device corresponding to the logical address. For example, the unique information of the household device may represent the physical address as the MAC address.

The reason for using both the unique information (e.g., MAC address), which is the physical address, and the logical address is as follows.

The physical address is an address used only between the master modem 130 and the slave modem 350, and the logical address is an address used only between the controller 110 and the device. In terms of the controller 110 and the device, the logical address is not changed, even though the modem uses the ZigBee communication or the PLC. The address system may be different depending on the communication scheme of the modem. Referring to FIG. 4, since information is stored in the information storage unit 133 of the master modem 130 and the information storage unit 353 of the slave modem 350, the contents of the information storage units 133 and 353 are not deleted even in the case of power failure. Accordingly, even though power is resupplied after abrupt power failure, information of all installed devices may be directly. used with easy.

Referring to FIG. 3, step (f) S600 may include steps (f-1), (f-2), (f-3) and (f-4) (S610, S630, S650 and S670). FIG. 3 shows steps (e-1) to (e-3) (S510 to S550) and steps (f-1) to (f-4) (S610 to S670). However, according to embodiments, only steps (f-1) to (f-4) (S610 to S670) may be performed after S500 of FIG. 1, and may be performed, while skipping steps (f-1) to (f-4) (S610 to S670).

In step (f-1) S610, the controller 110 requests the control of the household device 370 or 300 to the master modem 130 by using the registered logical address of the household device.

In step (f-2) S630, the master modem 130 transmits the control request of the household device 370 or 300 to the slave modem 350 of the household device by using the unique information of the household device corresponding to the logical address.

In step (f-3) S650, the slave modem 350 controls the household device 370 or 300 according to the control request, receives the control response from the household device, and transmits a response signal to the master modem 130.

In step (f-4) S670, the master modem 130 transmits the received response signal to the controller 110.

A system for association between a controller and a device in a home network in accordance with a second embodiment of the present invention will be described in detail with reference to the accompanying drawings. FIG. 4, the above-described embodiments regarding association between the controller and the device in the home network, and FIGS. 1 to 3 may be referred to, and redundant descriptions may be omitted.

FIG. 4 is a block diagram schematically showing a system for association between a controller and a device in a home network in accordance with an embodiment of the present invention.

Referring to FIG. 4, the system for association between a controller and a device in a home network in accordance with an embodiment of the present invention may include a controller 110, a master modem 130, a slave modem 350, and a household device 370. The controller 110 and the master modem 130 belong to a home server such as a gateway 100 or a wall pad, and the slave modem 350 and the household device 370 belong to a single device 300. The device 300 and the household device 370 may be the same.

The home network may be a ZigBee network, and the master modem 130 may be a Zig Bee master. The slave modem 350 may be a ZigBee slave.

Referring to FIGS. 1 and 2, the controller 110 of FIG. 4 communicates with the household device 370 or 300 belonging to the home network and manages the control of the household device. For example, the controller 110 may be the home network server, the gateway, or the wall pad 100 itself, which constitutes the home network, or may be a controller therefor. The controller 110 may request a registration of a specific device to the master modem 130. In this case, the specific device, whose registration is requested by the controller 110, is a household device whose home network association is permitted in the user's home network server, gateway, or wall pad 100. For example, the controller 110 may previously register the information of the household device, whose association is permitted, in the master modem 130. The controller 110 may transmit the unique information of the household device to the master modem 130 by inputting the information of the specific household device, whose home network association is permitted in the user's home network server, gateway or wall pad 100. In addition, the information of the household device 370 or 300 may be provided through the master modem 130 to the controller 110 through the association procedure according to the home network communication association request from the slave modem 350 of the household device 370 or 300. In this case, if the information of the household device 370 or 300 is displayed in the home network server, gateway or wall pad 100 through the controller 110, the association of the specific household device may be permitted when the selects the displayed information. The unique information of the household device, whose association is permitted, may be transmitted from the controller 110 to the master modem 130 and be registered and/or stored therein.

Referring to FIGS. 2 and 3, the controller 10 of FIG. 4 may store and/or register the logical address and the equipment information received from the master modem 130 and request the control of the household device to the master modem 130 using the stored and/or registered logical address of the household device.

Referring to FIG. 4, the master modem 130 may include a communication unit 131 and an information storage unit 133. The communication unit 131 may communicate with the slave modem 350, and the information storage unit 133 may store/register the information whose registration is requested by the controller 110. Referring to FIG. 2, MAC address of the specific device, which is transmitted from the controller 110, may be stored/registered in the table, which is the information storage unit 133. In addition, the information storage unit 133 may store and/or register the information of the logical address allocated according to the equipment information of the household device 370 or 300. For example, the master modem 130 may be a ZigBee master installed in the home network server, gateway or wall pad 100.

The specific features of the master modem 130 of FIG. 4 will be described with reference to FIGS. 1 and 2. The master modem 130 may register the unique information of the specific device according to the specific device registration request from the controller 110. In this case, the unique information of the device 300 may be MAC address.

In addition, the master modem 130 may receive information including the unique information of the household device from the slave modem 350 of the household device requesting the home network association through the home network communication association procedure. The home network communication association procedure is exemplarily shown in FIG. 2. Specifically, the ZigBee association is shown in FIG. 2. The master modem 130 may determine whether the unique information of the household device 370 received from the slave modem 350 of the household device through the home network communication association procedure exists on the information in which the unique information of the specific devices is registered. If it is determined that the unique information does not exist, the master modem 130 may request the exclusion of the household device 370. On the other hand, if it is determined that the unique information exists, the master modem 130 may transmit the equipment information of the household device 370, which is received from the slave modem 350, to the controller 110.

Another example will be described with reference to FIGS. 2 and 3. The master modem 130 of FIG. 4 may allocate the logical address corresponding to the equipment information of the household device received from the slave modem 130. The master modem 130 may transmit the allocated logical address to the slave modem 350, and may perform the home network communication association by transmitting the allocated logical address information and the equipment information to the controller 110.

The logical address may be a fixed address allocated to each household device.

In addition, the master modem 130 may control the household device by transmitting the control request to the slave modem 350 using the unique information of the household device according to the control request of the household device 370 or 300 from the controller 110.

The slave modem 350 will be described with reference to FIG. 4, in addition to FIGS. 1 and 2. Referring to FIG. 4, the slave modem 350 is installed on the household device 300 and may include a communication unit 351 and an information storage unit 353. The communication unit 351 may communicate with the master modem 130. The slave modem 350 requests the home network communication association of the household device to the master modem 130. In this case, the information including the unique information of the household device 300 may be transmitted to the master modem 130 through the home network communication association procedure. As the home network communication association procedure, the ZigBee association procedure is exemplarily shown in FIG. 2. A detailed description refers to the embodiments of the methods for association between the controller 110 and the device in the home network.

In addition, the slave modem 350 may receive the exclusion request from the master modem 130 and perform the exclusion of the household device 370 or 300. Furthermore, the slave modem 350 may transmit the equipment information of the household device 370 or 300 to the master modem 130.

Referring to FIGS. 2 and 3, the slave modem 350 of FIG. 4 may control the household device 370 or 300 according to the control request received from the master modem 130. In this case, the slave modem 350 may receive the control response signal from the household device 370 or 300 and transmit the control response signal to the master modem 130. At this time, the master modem 130 may transmit the received control response signal to the controller 110.

Referring to FIG. 4, the household device associates with the controller 110 through the slave modem 350. The household device may be controlled through the slave modem 350 according to the control request from the associated controller 110.

In accordance with exemplary embodiments of the present invention, when the controller and the device associate with each other in the home network, it is possible to prevent incorrect association with devices belonging to other home networks. Therefore, the controller and the device may associate with each other more correctly.

Moreover, incorrect association caused by automatic association according to a distance or signal strength may be prevented, and the incorrect association may be corrected.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A method for association between a controller and a device in a home network, which comprises:
(a) registering, by a master modem, unique information of a specific device when the controller requests a registration of the specific device;
(b) receiving, by the master modem, information including unique information of a household device from a slave modem through a home network communication association procedure;
(c) determining, by the master modem, whether the unique information of the household device received through the home network communication association procedure exists on the registered information;
(d) if it is determined that the unique information of the household device does not exist, requesting, by the master modem, an exclusion of the household device requesting the association according to the home network communication association procedure, and excluding the household device from the home network association; and
(e) if it is determined that the unique information of the household device exists, performing, by the master mode, the home network association by transmitting the unique information of the household device, which is received from the slave modem, to the controller.

2. The method according to claim 1, wherein step (e) comprises:
(e-1) allocating, by the master modem, a logical address corresponding to the equipment information of the household device received from the slave modem;
(e-2) transmitting, by the master modem, information of the logical address allocated in step (e-1) and the equipment information to the controller, and registering, by the controller, the logical address and the equipment information; and
(e-3) transmitting, by the master modem, the information of the logical address allocated in step (e-1) to the slave modem of the corresponding household device, and registering, by the slave modem, the information of the logical address, and the method further comprises:
(f) requesting, by the controller, the control of the household device to the master modem by using the registered logical address of the household device, and controlling, by the master modem, the household device by transmitting a control request of the household device by using the unique information of the household device corresponding to the logical address.

3. The method according to claim 2, wherein step (f) comprises:
(f-1) requesting, by the controller, the control of the household device to the master modem by using the registered logical address of the household device;
(f-2) transmitting, by the master modem, the household device control request to the slave modem of the household device by using the unique information of the household device corresponding to the logical address;
(f-3) controlling, by the slave modem, the household device according to the control request, receiving a control response from the household device, and transmitting a control response signal to the master modem; and
(f-4) transmitting, by the master modem, the received control response signal to the controller.

4. The method according to claim 1, wherein in step (e), the equipment information of the household device transmitted to the controller is contained in the information including the unique information of the household device received by the master modem through the home network communication association procedure in step (b), and the master modem allocates a logical address corresponding to the equipment information of the household device and transmits the logical address and the equipment information to the controller.

5. The method according to claim 1, wherein in step (e), the equipment information of the household device transmitted to the controller is information received by requesting to the slave modem after it is determined in step (c) that the unique information of the household device exists, and the master modem allocates a logical address corresponding to the equipment information of the household device and transmits the logical address and the equipment information to the controller.

6. The method according to claim 1, wherein the unique information of the device is MAC address and, in step (e), the master modem allocates a logical address corresponding to the equipment information of the household device and transmits the logical address and the equipment information to the controller.

7. The method according to claim 2, wherein the logical address is a fixed address allocated to the household device.

8. The method according to claim 1, wherein the master modem is a ZigBee master, and the slave modem is a Zig Bee slave.

9. A system for association between a controller and a device in a home network, which comprises:
a controller configured to communicate with a household device belonging to the home network and control the household device;
a master modem configured to register unique information of a specific device according to a specific device registration request from the controller, determine whether the unique information of the household device received from a slave modem of the household device through a home network communication association procedure exists on the registered information, request an exclusion of the household device if it is determined the unique information does not exist, and transmit the unique information of the household device received from the slave modem to the controller if it is determined that the unique information exists;
a slave modem installed on the household device and configured to communicate with the master modem, request the home network communication association of the household device to the master modem, transmit information including the unique information of the household device to the master modem through the home network communication association procedure, perform exclusion of the household device if received an exclusion request from the master modem, and transmit equipment information of the household device to the master modem; and
the household device configured to associate with the controller through the slave modem and be controlled through the slave modem according to a control request from the associated controller.

10. The system according to claim 9, wherein the master modem allocates a logical address corresponding to the equipment information of the household device received from the slave modem, transmits the allocated logical address to the slave modem, performs the home network communication association by transmitting the allocated logical address and the equipment information to the controller, and transmits a control request to the slave modem by using the unique information of the household device according to the household device control request from the controller, and
the controller registers the logical address and the equipment information received from the master modem, and requests the control of the household device to the master modem by using the registered logical address of the household device.

11. The system according to claim 10, wherein the slave modem controls the household device according to the control request, receives a control response from the household device, and transmits a control response signal to the master modem, and the master modem transmits the received control response signal to the controller.

12. The system according to claim 9, wherein the unique information of the device is MAC address, and the logical address is a fixed address allocated to the household device.

13. The system according claim 9, wherein the master modem is a ZigBee modem, and the slave modem is a ZigBee slave.
